(19) United States
(12) Patent Application Publication
(10) Pub. No.: US 2023/0358535 A1
(43) Pub. Date: Nov. 9, 2023

(54) RANGING DEVICE, COMPUTER-READABLE RECORDING MEDIUM STORING RANGING PROGRAM, AND RANGING METHOD

(71) Applicant: Fujitsu Limited, Kawasaki-shi (JP)

(72) Inventors: Koichi IIDA, Kobe (JP); Koichi TEZUKA, Shibuya (JP); Katsushi SAKAI, Zama (JP); Takeshi MORIKAWA, Yokohama (JP)

(73) Assignee: Fujitsu Limited, Kawasaki-shi (JP)

(21) Appl. No.: 18/150,461

(22) Filed: Jan. 5, 2023

(30) Foreign Application Priority Data
Mar. 31, 2022 (JP) 2022-057903

(51) Int. Cl. G01C 3/08; G01S 7/4865; G01S 17/894

(52) U.S. Cl. CPC G01C 3/08; G01S 7/4865; G01S 17/894

(57) ABSTRACT

A ranging device includes: a light projection circuit configured to project laser light; a light receiving circuit configured to receive reflected light of the laser light projected by the light projection circuit; and a processor configured to: measure a time from a time when the light projection circuit projects the laser light to a time when the light receiving circuit receives the reflected light; calculate a first distance from the light projection circuit to the light receiving circuit via a ranging target, by using the time; and specify a third distance between the light projection circuit and the ranging target, by using a light projection angle of the laser light, the first distance, and a second distance between the light projection circuit and the light receiving circuit when a ratio of the first distance with respect to the second distance is equal to or less than a predetermined threshold.

### CROSS REFERENCE TO RELATED APPLICATION

This application is based upon and claims the benefit of priority of the prior Japanese Patent Application No. 2022-57903, filed on Mar. 31, 2022, the entire contents of which are incorporated herein by reference.

### FIELD

The embodiment discussed herein is related to a ranging device, a ranging program, and a ranging method.

### BACKGROUND

Traditionally, there is a photoelectric sensor that includes a light projection unit that includes a light emission element and projects light emitted by the light emission element and changes a light projection direction, a light receiving unit that includes a light receiving lens and a light receiving element and receives reflected light from a ranging target of the projected light by the light receiving element through the light receiving lens and outputs a light reception signal, an angle detection unit that detects an incident angle of light entering the light receiving lens, a level discrimination unit that discriminates the light reception signal output from the light receiving unit at a threshold level, and a level control unit that changes the threshold level according to characteristics of the light receiving lens, using the angle detected by the angle detection unit. Furthermore, there is a laser ranging device using this photoelectric sensor. Since an interval between the light projection unit and the light receiving unit is sufficiently small than a measured distance, approximate calculation that ignores the interval between the light projection unit and the light receiving unit is performed in distance measurement.

Japanese Laid-open Patent Publication No. 07-270535 is disclosed as related art.

### SUMMARY

According to an aspect of the embodiments, a ranging device includes: a light projection circuit configured to project laser light; a light receiving circuit configured to receive reflected light of the laser light projected by the light projection circuit; and a processor configured to: measure a time from a time when the light projection circuit projects the laser light to a time when the light receiving circuit receives the reflected light; calculate a first distance from the light projection circuit to the light receiving circuit via a ranging target, by using the time; and specify a third distance between the light projection circuit and the ranging target, by using a light projection angle of the laser light, the first distance, and a second distance between the light projection circuit and the light receiving circuit when a ratio of the first distance with respect to the second distance is equal to or less than a predetermined threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an overall configuration of a posture recognition system 400 according to an embodiment;

FIG. 2 is a diagram illustrating an example of an appearance of a master device 100M;

FIGS. 3A to 3C are diagrams for explaining raster scan of the master device 100M;

FIG. 4 is a diagram for explaining internal configurations of a micro controller unit (MCU) 110 and a field programmable gate array (FPGA) 130M of the master device 100M;

FIG. 5 is an explanatory diagram of a time of flight (TOF) method;

FIG. 6A is a diagram illustrating an example of a positional relationship between a ranging target 1 and the master device 100M;

FIG. 6B is a diagram illustrating an example of the positional relationship between the ranging target 1 and the master device 100M;

FIG. 7 is a diagram illustrating a distribution of errors included in a ranging result of the TOF method with respect to a distance between a ranging target and a light projection unit A;

FIG. 8 is a diagram for explaining a ranging method in a case where the ranging target 1 is close;

FIG. 9 is a flowchart illustrating an example of processing executed by a light projection control unit 130;

FIG. 10 is a flowchart illustrating processing of the MCU 110;

FIG. 11 is a diagram illustrating an application example of the posture recognition system 400; and

FIG. 12 is a diagram illustrating a hardware configuration example of the master device 100M.

### DESCRIPTION OF EMBODIMENTS

By the way, in a case where the ranging target is close to the light projection unit and the interval between the light projection unit and the light receiving unit is not sufficiently small than the measured distance, an error of the measured distance increases and a traditional laser ranging device cannot appropriately obtain a measured distance through approximate calculation.

Therefore, an object is to provide a ranging device, a ranging program, and a ranging method that can appropriately obtain a distance between a light projection unit and a ranging target even if the ranging target is close to the light projection unit.

Hereinafter, an embodiment to which a ranging device, a ranging program, and a ranging method according to the present disclosure are applied will be described.

### Embodiment

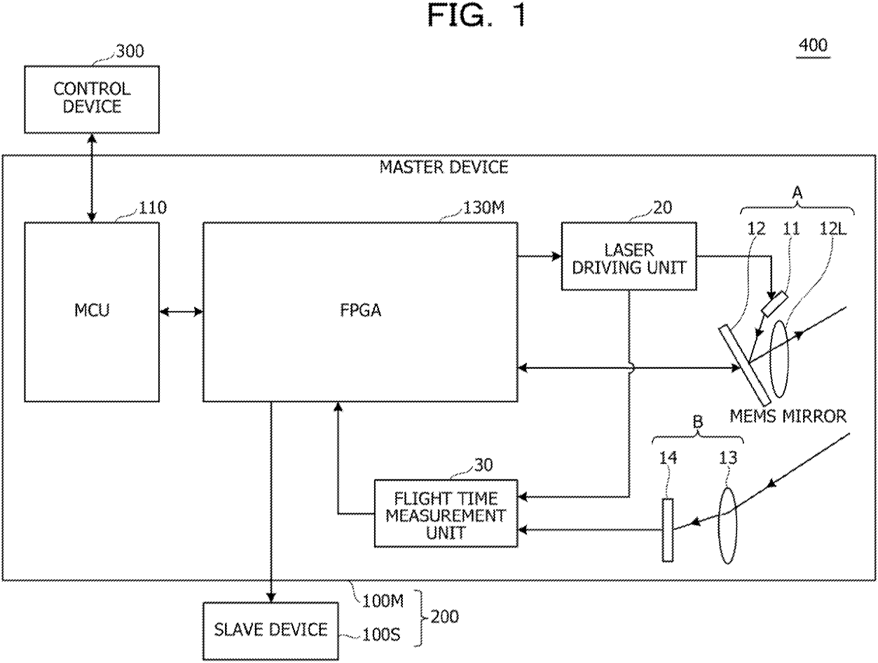

FIG. 1 is a schematic diagram illustrating an overall configuration of a posture recognition system 400 according to an embodiment. As illustrated in FIG. 1, the posture recognition system 400 includes a master device 100M, a slave device 100S, and a control device 300. The master device 100M and the slave device 100S are examples of a ranging device. Although the posture recognition system 400 may include a plurality of the slave devices 100S, here, a form in which the posture recognition system 400 includes the single slave device 100S will be described as an example.

The master device 100M and the slave device 100S construct a sensor system 200. Therefore, the posture recognition system 400 includes the sensor system 200 and the control device 300. The master device 100M, the slave device 100S, and the control device 300 are coupled via a wired or wireless network so as to perform data communication. Note that, in a case where there is a plurality of the slave devices 100S, the sensor system 200 includes the plurality of slave devices 100S.

The posture recognition system 400 is a system that recognizes a posture of a ranging target, by measuring a distance to each part of the ranging target, by scanning (scan) the ranging target with laser light emitted from the master device 100M and the slave device 100S, using the master device 100M and the slave device 100S as a ranging device (measurement device). The ranging target may be any object, but here, an athlete who performs gymnastics is taken as an example.

The master device 100M and the slave device 100S emit laser light at timings (measurement cycles) different from each other and receive reflected waves reflected by the ranging target, through synchronization control in cooperation with each other. This is because, if laser light emitted from a device other than the own device is wrongly received, it is not possible to obtain a correct measurement result. Therefore, the master device 100M and the slave device 100S alternately emit and receive laser light so that periods when the respective devices emit or receive the laser light do not overlap. Note that, in a case where there is the plurality of slave devices 100S, it is sufficient that the emissions or the receptions of laser light of each of the master device 100M and the plurality of slave devices 100S do not overlap. In this case, the master device 100M and one of the plurality of slave devices 100S may alternately emit and receive laser light so that periods of laser light emission and reception do not overlap.

Since the master device 100M and the slave device 100S have a similar hardware configuration, a hardware configuration of the master device 100M is illustrated in FIG. 1.

The master device 100M includes a light emission device 11, a micro electro mechanical system (MEMS) mirror 12, a light projection lens 12L, a light receiving lens 13, a light receiving element 14, a laser driving unit 20, a flight time measurement unit 30, a micro controller unit (MCU) 110, and a FPGA 130M. The MCU 110 is an example of a control unit. The light emission device 11, the MEMS mirror 12, and the light projection lens 12L construct a light projection unit A that projects laser light emitted by the light emission device 11. The light receiving lens 13 and the light receiving element 14 construct a light receiving unit B that receives reflected light of laser light.

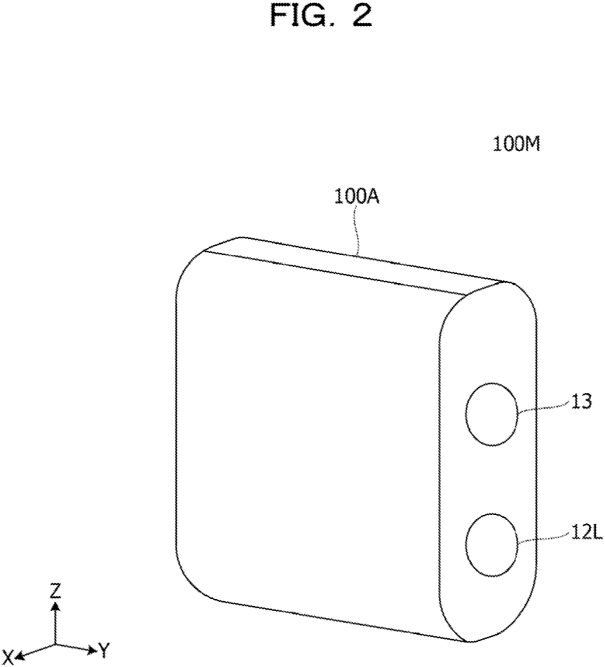

FIG. 2 is a diagram illustrating an example of an appearance of the master device 100M. Here, an XYZ coordinate system as an orthogonal coordinate system is defined and described. A direction parallel to an X axis (X direction), a direction parallel to a Y axis (Y direction), and a direction parallel to a Z axis (Z direction) are orthogonal to each other. Furthermore, plan view means to view an XY plane. Furthermore, as an example, the Z direction is described as a vertical direction. However, this does not indicate a universal vertical relationship.

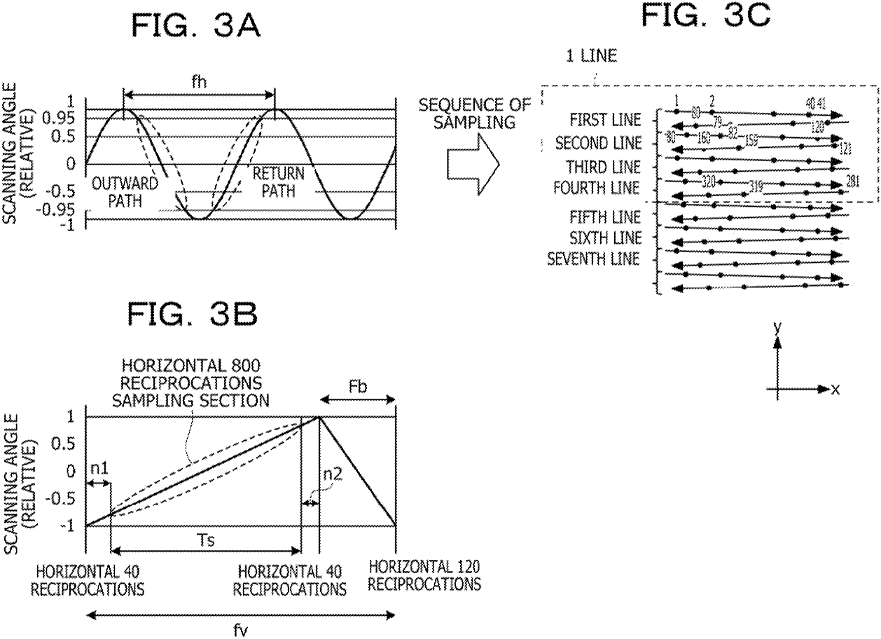

The master device 100M includes a housing 100A. On a side surface on a + Y direction side of the housing 100A, the light projection lens 12L and the light receiving lens 13 are exposed. As an example, the light projection lens 12L and the light receiving lens 13 are arranged vertically (up and down). The master device 100M is a binocular measurement device in which the light projection lens 12L and the light receiving lens 13 are exposed. Both of optical axes of the light projection lens 12L and the light receiving lens 13 are parallel to the Y axis. A distance between the centers of the light projection lens 12L and the light receiving lens 13 is about 10 cm as an example. Here, before a specific configuration in the master device 100M is described, raster scan of the master device 100M will be described with reference to FIGS. 3A to 3C.

### Raster Scan of Master Device 100M

FIGS. 3A to 3C are diagrams for explaining raster scan of the master device 100M. In FIGS. 3A to 3C, the master device 100M will be described. However, the slave device 100S also performs similar raster scan. In the cooperation between the master device 100M and the slave device 100S, the master device 100M alternately emits laser light and performs measurement through the synchronization control described above.

FIG. 3A illustrates a horizontal direction sampling region (horizontal axis indicates time, and vertical axis indicates scanning angle in horizontal direction of laser light). FIG. 3B illustrates a vertical direction sampling region (horizontal axis indicates time (horizontal reciprocating scanning period of 200 reciprocations of MEMS mirror 12), and vertical axis indicates scanning angle in vertical direction of laser light). FIG. 3C illustrates a position of sampling data on a reflective surface (x and y axes) of the MEMS mirror 12.

In FIG. 3A, the vertical axis indicates a relative scanning angle in the horizontal direction. “+ 1” and “- 1” in the vertical axis represent a scanning amplitude of the MEMS mirror 12 in the horizontal direction, and indicate that the scanning amplitude in the horizontal direction is “1”. The relative scanning angle can be values between ± 1, and “- 1” in the vertical axis indicates the smallest scanning angle in the horizontal direction, and “1” indicates the largest scanning angle in the horizontal direction. Reciprocation of the relative scanning angle in the horizontal direction between “- 1” and “1” reciprocates the scanning angle in the horizontal direction once. A horizontal driving signal is a sine wave.

In FIG. 3B, the vertical axis indicates a relative scanning angle in the vertical direction. “+ 1” and “- 1” in the vertical axis represent a scanning amplitude of the MEMS mirror 12 in the vertical direction, and indicate that the scanning amplitude in the vertical direction is “1”. “- 1” in the vertical axis indicates the smallest scanning angle in the vertical direction, and “1” in the vertical axis indicates the largest scanning angle in the vertical direction. Reciprocation of the relative scanning angle in the vertical direction between “-1” and “1” reciprocates the scanning angle in the vertical direction once. Each angle obtained by dividing the relative scanning angle in the vertical direction by 1000 corresponds to each line.

Here, it is assumed that the number of samplings per frame (one frame period) be 64,000 points (raster scan (progressive) of x axis 320 * y axis 200), a resonance frequency (unique frequency) fh of the MEMS mirror 12 in the horizontal direction be about 28.3 Hz (one cycle, one frame data), and data sampling be 3.2 MHz. The number of frames is 30 per second.

As illustrated in FIG. 3A, the MEMS mirror 12 vibrates in the horizontal direction at the resonance frequency fh (for example, about 28.3 kHz) with a driving signal and samples 80 points in one section including a pair of an outward path and a return path at a fixed sampling interval of 320 ns. The MEMS mirror 12 samples 320 points in four reciprocations in the horizontal direction (refer to FIG. 3C). The MEMS mirror 12 generates a trigger of sampling start based on a sensor signal of the MEMS mirror 12 for each section. As a result, as illustrated in FIG. 3C, sampling data of 320 points is acquired in four reciprocations. In one reciprocation, 80 points are sampled so as to fill a gap by shifting the horizontal angle for each reciprocation. In one reciprocation, 40 points are sampled in an outward path from “0.95” to “- 0.95”, and 40 points are sampled in a next return path from “- 0.95” to “0.95”.

In FIG. 3B, the MEMS mirror 12 vibrates in the vertical direction at a frequency fv (for example, about 28.3 Hz) with a driving signal. The MEMS mirror 12 increases the scanning angle in a measurement period Ts of an entire period of horizontal reciprocations (200 reciprocations in total) and decreases an operating angle in a period other than the measurement period Ts (corresponding to flyback period Fb). Note that, since an effect of an amplitude is excluded in a predetermined period of each of start and end of the period when the scanning angle increases (horizontal 40 reciprocations), the predetermined periods are assumed as dead bands n1 (horizontal 40 reciprocations) and n2 (horizontal 40 reciprocations) that are not used for measurement. It is assumed that a sampling period of horizontal 800 reciprocations excluding the dead bands n1 and n2 be the measurement period Ts. Note that, the flyback period Fb corresponds to horizontal 120 reciprocations. The dead bands n1 and n2 are non-light-emission periods of the MEMS mirror 12 in a horizontal resonance direction.

In the synchronization control in which the master device 100M and the slave device 100S are in cooperation, laser light emissions are strictly synchronized per frame data, and a light emission timing is controlled so as not to cause mutual interferences. Then, by sampling 64,000 points per frame, three-dimensional point cloud data of the 64,000 points is acquired.

In order to acquire such three-dimensional point cloud data, the master device 100M controls emission of laser light, with reference to a timing when the scanning angle of the MEMS mirror 12 in the horizontal direction becomes zero (hereinafter, referred to as zero timing). Furthermore, the slave device 100S controls emission of laser light with reference to the zero timing supplied from the master device 100M.

Furthermore, in the synchronization control in which the master device 100M and the slave device 100S are in cooperation, for example, there is a case where an angle of view of a case where the MEMS mirror 12 performs scanning in a raster scan method is changed, in accordance with a change in a distance to a ranging target caused by movement of the ranging target. The angle of view is changed based on an amplitude target value input from a main control unit 110A.

### Configuration of Master Device 100M

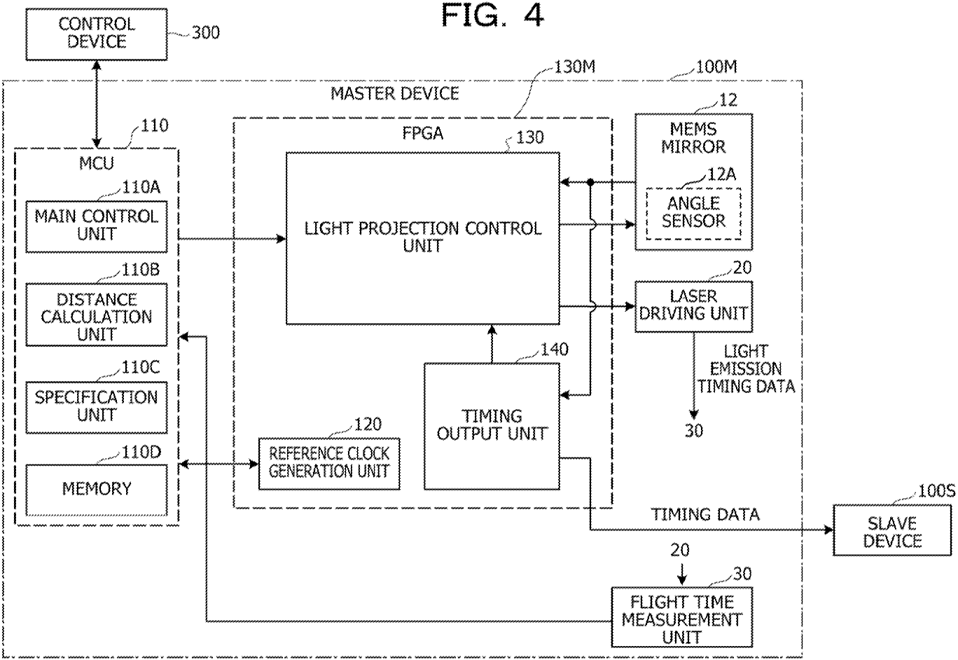

Here, a configuration of the master device 100M will be described with reference to FIGS. 1 and 4. FIG. 4 is a diagram for explaining internal configurations of the MCU 110 and the FPGA 130M of the master device 100M. In FIG. 4, in addition to the MCU 110 and the FPGA 130M of the master device 100M, the MEMS mirror 12, the laser driving unit 20, and the flight time measurement unit 30 of the master device 100M are illustrated, and the slave device 100S and the control device 300 are illustrated. In FIG. 4, the light emission device 11, the light receiving lens 13, and the light receiving element 14 are omitted. Here, the master device 100M, the slave device 100S, the control device 300, and the posture recognition system 400 will be described with reference to FIGS. 1 and 4.

The light emission device 11 is a device that emits laser light in accordance with an instruction of the laser driving unit 20 and includes a light emission element such as a semiconductor laser. As an example, the light emission device 11 emits pulse-like laser light at a predetermined sampling cycle. The FPGA 130M controls the laser driving unit 20. A timing when the laser driving unit 20 instructs the light emission device 11 to emit pulse-like laser light is sent from the laser driving unit 20 to the flight time measurement unit 30. For example, the flight time measurement unit 30 acquires the emission timing of the pulse-like laser light.

The MEMS mirror 12 is a mirror that changes an angle of laser light that is three-dimensionally emitted. The MEMS mirror 12 is a two-axis rotation type mirror, in which the angle of emitted laser light three-dimensionally changes, for example, due to changes in a rotation angle of a horizontal axis and a rotation angle of a vertical axis. The rotation angle of the horizontal axis is referred to as a horizontal angle H, and the rotation angle of the vertical axis is referred to as a vertical angle V. The FPGA 130M instructs the horizontal angle H and the vertical angle V of the MEMS mirror 12. The pulse-like laser light emitted from the light emission device 11 is deflected according to the horizontal angle H and the vertical angle V of the MEMS mirror 12.

The pulse-like laser light reflected by the MEMS mirror 12 is emitted to a ranging target, scattered (reflected), and returns to the light receiving lens 13. This returning light is collected by the light receiving lens 13 and is received by the light receiving element 14.

The MEMS mirror 12 normally utilizes resonance for at least one axis of the two axes, namely, the horizontal axis and the vertical axis, in order to increase a scanning speed and also to increase a drive angle. In the present embodiment, as an example, normally, resonance is utilized in the horizontal direction in which the number of reciprocations is large.

Furthermore, the MEMS mirror 12 includes an angle sensor 12A. The angle sensor 12A outputs angle data representing an angle (drive angle) of the MEMS mirror 12 to the FPGA 130M. The angle represented by the angle data sinusoidally changes as the scanning angle illustrated in FIG. 3A, with time.

The light receiving lens 13 transmits a reflected wave that the laser light (pulse-like laser light), which is reflected by the MEMS mirror 12, reflected by the ranging target, collects light, and guides the light to the light receiving element 14. The light receiving lens 13 collects light, and the light receiving element 14 receives light.

The light receiving element 14 is, for example, a photo diode (PD), and for example, an avalanche photo diode (APD) can be used. The light receiving element 14 outputs light-receiving timing data representing a light-receiving timing to the flight time measurement unit 30.

The laser driving unit 20 is a driving circuit that causes the light emission device 11 to emit light, based on a light emission control command input from the FPGA 130M. The laser driving unit 20 outputs light emission timing data representing a timing when the light emission device 11 is caused to emit light to the flight time measurement unit 30.

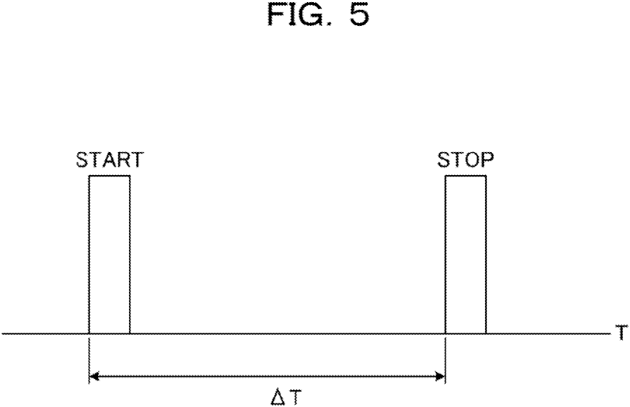

The flight time measurement unit 30 adopts the time of flight (TOF) method so as to measure a round-trip time of light from when the light emission device 11 emits laser light to when the reflected light reflected by the ranging target is received by the light receiving element 14. FIG. 5 is an explanatory diagram of the TOF method. The light emission timing data in FIG. 5 represents a timing (START) at which the light emission device 11 emits pulse-like laser light. The light-receiving timing data represents a timing (STOP) at which the laser light returned from the ranging target is received.

As illustrated in FIG. 5, the flight time measurement unit 30 measures a round-trip time (ΔT) from the time when the light emission device 11 emits pulse-like laser light to the time when reflected light returns from the ranging target by executing binarization processing or the like. By multiplying the round-trip time by the light speed and dividing by two, it is possible to calculate a distance to the ranging target. Note that, a case where a value obtained by multiplying a half time of the round-trip time (ΔT/2) by the light speed can be used as the distance to the ranging target is a case where a distance between the MEMS mirror 12 and the light receiving element 14 is sufficiently short and can be ignored. Since the round-trip time (ΔT) can be measured each time when the light emission device 11 emits pulse-like laser light, the flight time measurement unit 30 can measure the round-trip time (ΔT) at the sampling cycle. The flight time measurement unit 30 outputs round-trip time data representing the round-trip time (ΔT) to the MCU 110 each time when the round-trip time (ΔT) is measured.

The control device 300 transmits a frequency of a reference clock signal that defines operation timings of the master device 100M and the slave device 100S to the master device 100M and the slave device 100S. The frequency transmitted from the control device 300 is received by the MCU 110.

The master device 100M sends a frame pulse (master frame pulse) and a line pulse (master line pulse) of the master device 100M to the inside of the master device 100M and the slave device 100S.

The MCU 110 is implemented by a computer that includes a central processing unit (CPU), a random access memory (RAM), a read only memory (ROM), a hard disk drive (HDD), an input/output interface, an internal bus, or the like. The MCU 110 includes the main control unit 110A, a distance calculation unit 110B, a specification unit 110C, and a memory 110D. The main control unit 110A comprehensively controls an operation of the master device 100M. The main control unit 110A, the distance calculation unit 110B, and the specification unit 110C are illustrated as functional blocks of functions of a program executed by the MCU 110. The memory 110D functionally represents a memory of the MCU 110.

The main control unit 110A receives data representing the frequency of the reference clock signal from the control device 300. The reference clock signal is a clock signal that defines the operation timings of the master device 100M and the slave device 100S. The main control unit 110A outputs the data representing the frequency of the reference clock signal to a reference clock generation unit 120. The reference clock generation unit 120 generates a reference clock and outputs the reference clock to the main control unit 110A. The main control unit 110A outputs the reference clock, input from the reference clock generation unit 120, to the FPGA 130M. Furthermore, the main control unit 110A outputs a phase target value at which the light emission device 11 is caused to emit light or the like to the FPGA 130M.

The distance calculation unit 110B is an example of a calculation unit and calculates a value obtained by multiplying a half time (ΔT/2) of the round-trip time represented by the round-trip time data input from the flight time measurement unit 30 by the light speed as a distance to the ranging target. The distance calculated by the distance calculation unit 110B is a distance calculated with the TOF method.

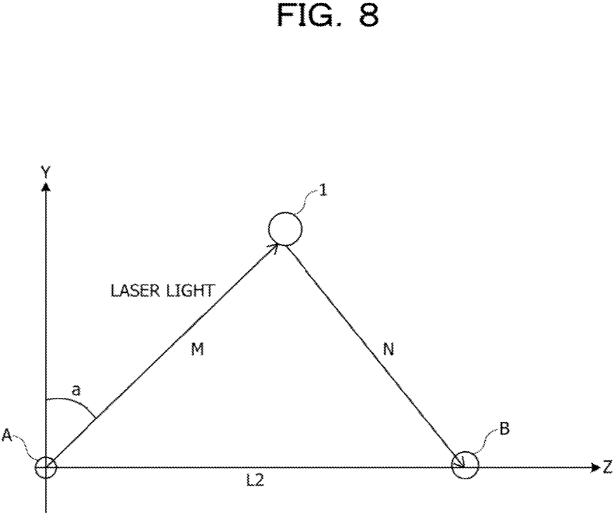

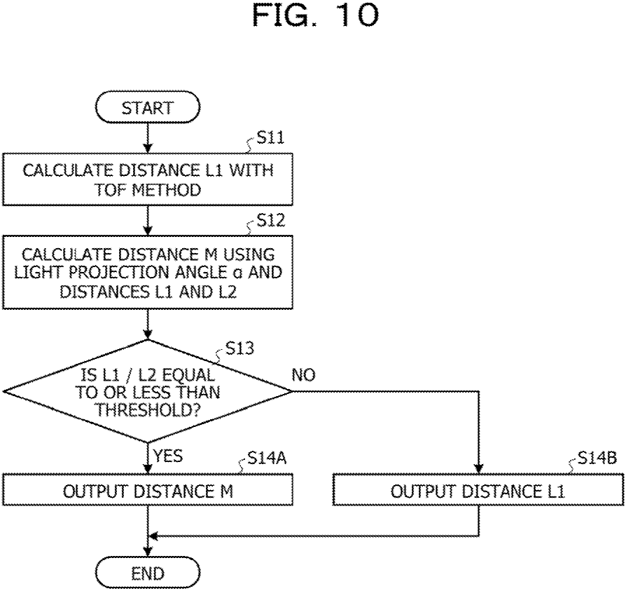

The specification unit 110C specifies a distance between the light projection unit A and the ranging target. Processing executed by the specification unit 110C will be described later with reference to FIGS. 8 and 10.

The memory 110D stores programs and data used when the main control unit 110A, the distance calculation unit 110B, and the specification unit 110C execute processing. Furthermore, the memory 110D stores angle table data that includes data representing the horizontal angle H and the vertical angle V at each sampling point and data representing a distance between the light projection unit A and the light receiving unit B. The angle table data that includes the data representing the horizontal angle H and the vertical angle V is data representing an angle when driving of the reflective surface of the MEMS mirror 12 is controlled when sampling is performed at 64,000 points in one frame illustrated in FIG. 3C and includes 64,000 pieces of data representing an angle in the horizontal direction and an angle in the vertical direction.

Upon acquiring the data representing the frequency of the reference clock signal from the main control unit 110A, the reference clock generation unit 120 generates the reference clock and outputs the reference clock to the main control unit 110A.

The FPGA 130M operates according to the reference clock input from the main control unit 110A and controls driving of the MEMS mirror 12 and controls light emission of the light emission device 11, based on an amplitude target value of the MEMS mirror 12, the phase target value at which the light emission device 11 is caused to emit light, or the like.

The FPGA 130M includes the reference clock generation unit 120, the light projection control unit 130, and a timing output unit 140.

The light projection control unit 130 controls driving of the MEMS mirror 12 based on the amplitude target value input from the main control unit 110A and the output of the angle sensor 12A of the MEMS mirror 12. Furthermore, the light projection control unit 130 outputs the light emission control command to make the laser driving unit 20 cause the light emission device 11 to emit light, based on the phase target value input from the main control unit 110A and the timing data representing the timing when the scanning angle of the MEMS mirror 12 input from the timing output unit 140 becomes zero. The amplitude target value represents a scanning amplitude. The scanning amplitude includes amplitudes in the two-axis (x axis and y axis) directions in FIG. 3C. The phase target value indicates a light emission timing with reference to the zero timing as a phase. For example, the phase target value indicates a light emission timing with reference to a start point of a frame as a phase.

The timing output unit 140 detects the zero timing of the scanning angle of the MEMS mirror 12, based on the angle data input from the angle sensor 12A of the MEMS mirror 12, generates the timing data representing the zero timing, and outputs the timing data to the light projection control unit 130 and the slave device 100S. The zero timing is a timing when the scanning angle of the MEMS mirror 12 in the horizontal direction becomes zero, in FIG. 3A.

The slave device 100S is different from the master device 100M in that the slave device 100S does not include the timing output unit 140 and operates based on the timing data supplied from the master device 100M.

### Problem in ToF Method

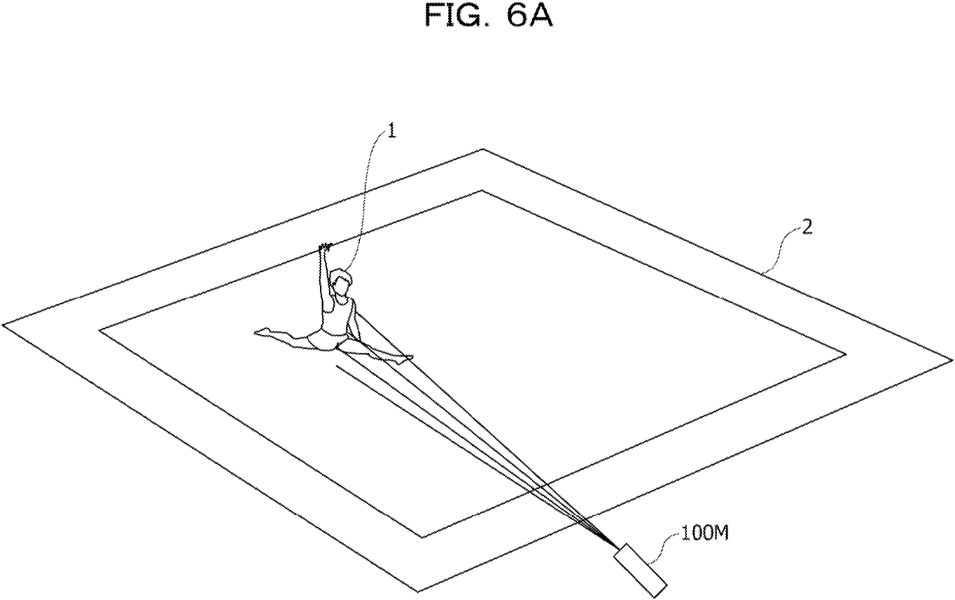

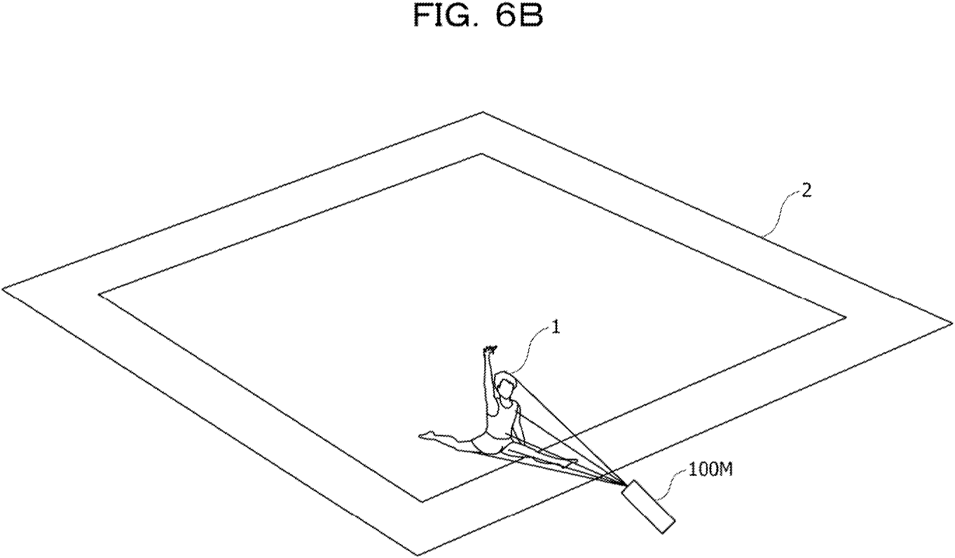

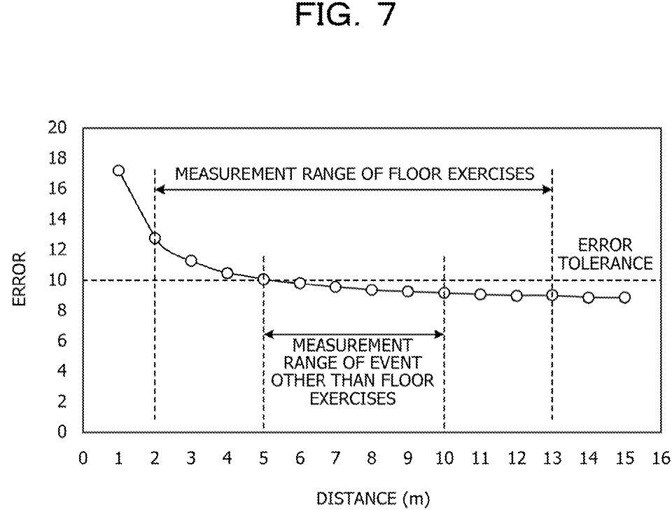

Here, a problem in the TOF method caused in a case where the distance between the ranging target and the light projection unit A is short will be described with reference to FIGS. 6A, 6B, and 7. FIGS. 6A and 6B are diagrams illustrating an example of a positional relationship between the ranging target 1 and the master device 100M. In FIGS. 6A and 6B, the ranging target 1 is an athlete who performs gymnastics. Among the gymnastics, since, for example, the floor exercises are performed, for example, on a floor 2 of 12 m × 12 m and the athlete (ranging target 1) runs freely on the floor 2, there is a case where the ranging target 1 is close to the master device 100M as illustrated in FIG. 6A and a case where the ranging target 1 is away from the master device 100M as illustrated in FIG. 6B. Note that, although the slave device 100S is not illustrated in FIGS. 6A and 6B, such a state similarly occurs in the slave device 100S.

FIG. 7 is a diagram illustrating a distribution of errors included in a ranging result of the TOF method, with respect to the distance between the ranging target and the light projection unit A. FIG. 7 illustrates the distribution of the errors of the ranging result with respect to the distance between the ranging target and the light projection unit A, for the ranging device for comparison that includes the distance calculation unit 110B and does not include the specification unit 110C.

In FIG. 7, the horizontal axis represents an actual distance (m) between the ranging target and the light projection unit A, and the vertical axis represents an error included in the ranging result of the TOF method. A value of the error is a normalized value (with no unit). Here, it is assumed that there be no problem in distance measurement if the error is equal to or less than 10 and an error tolerance (upper limit value) be 10.

As illustrated in FIG. 7, if the distance is equal to or more than five m, the error is equal to or less than the error tolerance. However, if the distance is less than five m, the error exceeds the error tolerance. Since a measurement range of an event other than the floor exercises is about five m to about 10 m, the error is equal to or less than the error tolerance and does not cause a problem. However, in the floor exercises, since the distance is about two m to about 13 m, the error exceeds the error tolerance in a case where the distance is equal to or less than five m. Therefore, in a case of the floor exercises, it is not possible to accurately perform ranging only by the TOF method, unlike the ranging device for comparison.

Note that, it is considered that the light projection unit A is away from the floor 2 so as to secure the distance equal or more than five m, in a state where the light projection unit A is closest to the ranging target. However, this increases the error when the ranging target is far and does not solve the problem.

### Ranging Method and Processing of Specification Unit 110C in a Case Where Ranging Target 1 Is Close

FIG. 8 is a diagram for explaining a ranging method in a case where the ranging target 1 is close. In FIG. 8, the light projection unit A, the light receiving unit B, and the ranging target 1 are illustrated. In FIG. 8, the Y axis and the Z axis are illustrated. Although the X axis is omitted, the + X direction is a direction that passes through the drawing from the front to the back. A light projection angle α corresponds to the vertical angle V of the MEMS mirror 12.

It is assumed that a distance between the light projection unit A and the light receiving unit B be L2, an actual distance between the light projection unit A and the ranging target 1 be M, and an actual distance between the ranging target 1 and the light projection unit A be N. L2 that is the distance between the light projection unit A and the light receiving unit B is an example of a second distance and is a distance between the center of the light projection lens 12L and the center of the light receiving element 14. The actual distance M between the light projection unit A and the ranging target 1 is an example of a third distance. The actual distance M between the light projection unit A and the ranging target 1 is a distance between the center of the light projection lens 12L and the ranging target 1.

A distance L1 obtained by the distance calculation unit 110B with the ToF method is a value obtained by adding the distance M and the distance N. The distance L1 (= M + N) obtained by the distance calculation unit 110B with the ToF method is an example of a first distance.

Since the distance L1 obtained with the ToF method is ½ of the round-trip distance, a case where positions of the light projection unit A and the light receiving unit B match and a case where the distance L2 between the light projection unit A and the light receiving unit B is negligibly small with respect to the distance M and the distance N are assumed as a premise. For example, in a case where the positions of the light projection unit A and the light receiving unit B do not match, if the distance L2 between the light projection unit A and the light receiving unit B is negligibly small with respect to the distance M and the distance N, the distance L1 obtained with the ToF method has a small error, and it is possible to accurately obtain the distance L1. However, in a case where the distance L2 between the light projection unit A and the light receiving unit B is too large to be ignored with respect to the distance M and the distance N, the error included in the distance L1 obtained with the ToF method is large.

Here, the distance M can be calculated according to the following formula (1), using the light projection angle α of the laser light. [Math. 1]

$$\text{M} = \frac{{\text{L1}}^{2} - {\text{L2}}^{2}}{2 \times \left(\text{L1} - \text{L2} \times \text{sin} α\right)} \qquad \text{(1)}$$

Therefore, when a ratio of the distance L1 with respect to the distance L2 between the light projection unit A and the light receiving unit B is equal to or less than a predetermined threshold, it is sufficient to calculate the distance M based on the formula (1) using the light projection angle α of the laser light. As the light projection angle α, it is sufficient to use the vertical angle V in the angle table data stored in the memory 110D. Furthermore, when the ratio of the distance L1 with respect to the distance L2 between the light projection unit A and the light receiving unit B is larger than the predetermined threshold, it is sufficient to adopt the distance L1 obtained by the distance calculation unit 110B with the ToF method.

As described above, the specification unit 110C calculates the distance M based on the formula (1) using the light projection angle a of the laser light when the ratio of the distance L1 with respect to the distance L2 is equal to or less than the predetermined threshold and specifies that the distance between the light projection unit A and the ranging target 1 is the distance M calculated based on the formula (1). Furthermore, the specification unit 110C specifies that the distance between the light projection unit A and the ranging target 1 is the distance L1 obtained by the distance calculation unit 110B with the ToF method when the ratio of the distance L1 with respect to the distance L2 is larger than the predetermined threshold.

Note that the specification unit 110C may use a simplified formula as the following formula (2), instead of the formula (1). [Math. 2]

$$\text{M} = \text{K1} \times \text{L1} - \left(\text{K2} \times \text{L2} \times α \times β\right) + γ \qquad \text{(2)}$$

Here, the reference K1 is a first coefficient set in a range of 0.3 ≤ K1 ≤ 0.7, for example. The reference K2 is a second coefficient set in a range of 0.01 ≤ K1 ≤ 0.03, for example. K1 and K2 are coefficients when the formula (1) is approximated to a linear function of L1 and L2. The reference β is a weight by an optical system such as the light projection unit A and the light receiving unit B, and, for example, 0.25 ≤ β ≤ 1. The reference γ is an offset, and 0 ≤ γ ≤ 1.

### Flowchart

### Processing Executed by Light Projection Control Unit 130

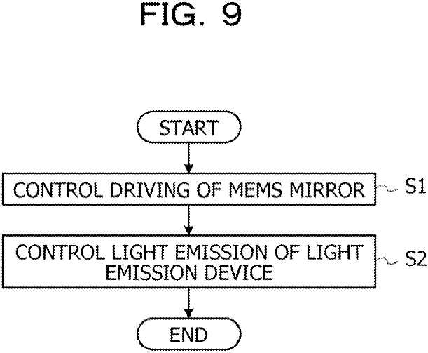

FIG. 9 is a flowchart illustrating an example of processing executed by the light projection control unit 130.

The light projection control unit 130 controls driving of the MEMS mirror 12 based on the amplitude target value input from the main control unit 110A and the output of the angle sensor 12A of the MEMS mirror 12 (step S1).

The light projection control unit 130 controls light emission of the light emission device 11 based on the phase target value input from the main control unit 110A and the timing data representing the timing when the scanning angle of the MEMS mirror 12 input from the timing output unit 140 becomes zero (step S2). In order to control light emission, the light projection control unit 130 outputs a light emission control command to make the laser driving unit 20 cause the light emission device 11 to emit light to the laser driving unit 20. The laser driving unit 20 generates light emission timing data based on the light emission control command and outputs the light emission timing data to the light emission device 11 and the flight time measurement unit 30.

The light projection control unit 130 repeatedly executes the processing in steps S1 and S2 and controls driving of the MEMS mirror 12 and controls light emission of the light emission device 11 so as to sample 64,000 points per frame as illustrated in FIG. 3C.

### Processing of MCU 110

FIG. 10 is a flowchart illustrating processing of the MCU 110. The flowchart illustrated in FIG. 10 realizes a ranging program and a ranging method according to the embodiment.

When the processing starts, the distance calculation unit 110B calculates a value obtained by multiplying the half time (ΔT/2) of the round-trip time represented by the round-trip time data input from the flight time measurement unit 30 by the light speed as the distance L1 to the ranging target 1, with the TOF method (step S11).

The specification unit 110C reads data representing the light projection angle a and data representing the distance L2 from the memory 110D and calculates the distance M based on the formula (1), using the light projection angle a, the distance L1, and the distance L2 (step S12). As the light projection angle a, it is sufficient to use the vertical angle V according to the sampling point in the angle table data stored in the memory 110D.

The specification unit 110C determines whether or not the ratio of the distance L1 with respect to the distance L2 (L1/L2) is equal to or less than a predetermined threshold (step S13).

When determining that the ratio of the distance L1 with respect to the distance L2 (L1/L2) is equal to or less than the predetermined threshold (S13: YES), the specification unit 110C calculates the distance M based on the formula (1) using the light projection angle a of the laser light, specifies that the distance between the light projection unit A and the ranging target 1 is the distance M, and outputs the distance M to the control device 300 (step S14A).

On the other hand, when determining that the ratio of the distance L1 with respect to the distance L2 (L1/L2) is not equal to or less than the predetermined threshold (S13: NO), the specification unit 110C specifies that the distance between the light projection unit A and the ranging target 1 is the distance L1 obtained by the distance calculation unit 110B with the ToF method and outputs the distance L1 to the control device 300 (step S14B).

The MCU 110 executes the flow illustrated in FIG. 10 each time when sampling is performed at 64,000 points per frame.

### Application Example of Posture Recognition System 400

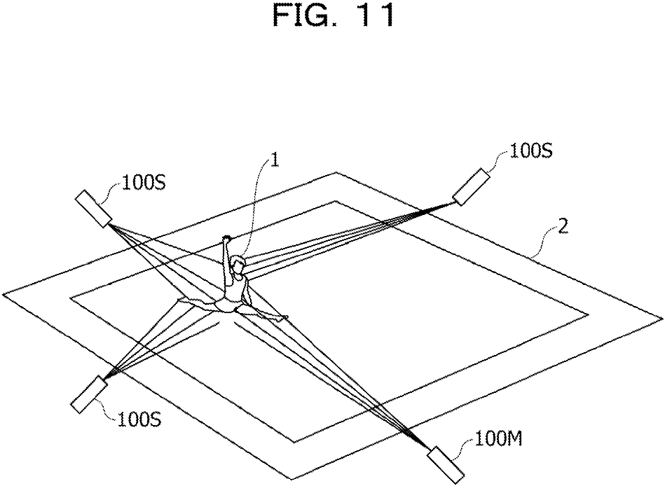

FIG. 11 is a diagram illustrating an application example of the posture recognition system 400. As illustrated in FIG. 11, one master device 100M and three slave device 100S are provided. These master device 100M and slave devices 100S are provided so as to surround the ranging target 1 (gymnast athlete in example in FIG. 11). There is a possibility that some parts of the athlete’s own body or equipment causes shadows, which produce a portion of the athlete’s body for which three-dimensional point cloud data may not be acquired. Therefore, the master device 100M and the slave devices 100S are provided so as to sandwich the athlete from the front and back sides. This makes it possible to measure detailed three-dimensional point data (posture data) of the athlete. By outputting the timing data for the latest one frame from the master device 100M to the own device (master device 100M) and the slave device 100S when the angle of view is changed, it is possible to prevent the deviation of the zero timing of the master device 100M. Therefore, in both states when the angle of view is not changed and the angle of view is changed, in a state where the master device 100M and the slave device 100S are synchronously controlled, it is possible to accurately measure the detailed three-dimensional point data (posture data) of the athlete.

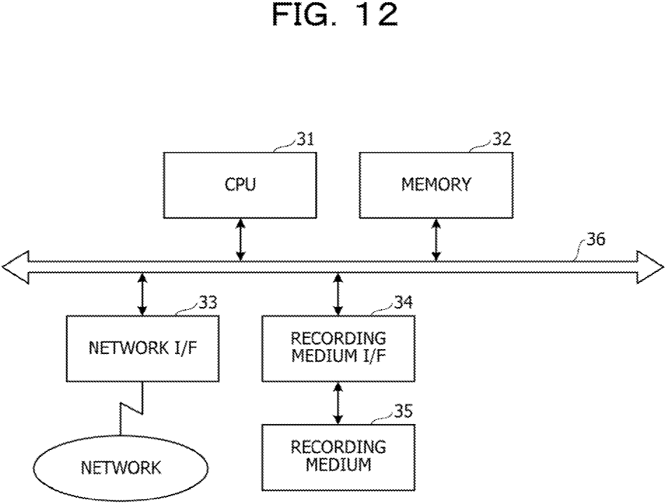

FIG. 12 is a hardware configuration example of the master device 100M. In FIG. 12, the master device 100M includes a CPU 31, a memory 32, a network interface (I/F) 33, a recording medium I/F 34, and a recording medium 35. Furthermore, the individual components are coupled to each other with a bus 36.

Here, the CPU 31 performs overall control of the master device 100M. The memory 32 includes, for example, a ROM, a RAM, a flash ROM, or the like. For example, the flash ROM or the ROM stores various programs, and the RAM is used as a work area for the CPU 31. The programs stored in the memory 32 are loaded into the CPU 31 to cause the CPU 31 to execute coded processing.

The network I/F 33 is coupled to a network through a communication line, and is coupled to another computer through the network. Then, the network I/F 33 manages an interface between the network and the inside, and controls input and output of data to and from another computer. The network I/F 33 is, for example, a modem, a local area network (LAN) adapter, or the like.

The recording medium I/F 34 controls reading and writing of data from and to the recording medium 35 under the control of the CPU 31. The recording medium I/F 34 is, for example, a disk drive, a solid state drive (SSD), a universal serial bus (USB) port, or the like. The recording medium 35 is a nonvolatile memory that stores the data written under the control of the recording medium I/F 34. The recording medium 35 is, for example, a disk, a semiconductor memory, a USB memory, or the like. The recording medium 35 may be attachable to and detachable from the master device 100M.

Note that, a function of each component included in the MCU 110 and the FPGA 130M of the master device 100M may be implemented by causing the CPU 31 to execute a program stored in a storage region such as the memory 32 or the recording medium 35 or by the network I/F 33.

### Effects

As described above, the master device 100M includes the light projection unit A that projects laser light, the light receiving unit B that receives the reflected light of the laser light projected by the light projection unit A, and the flight time measurement unit 30 that measures the time from the time when the light projection unit A projects laser light to the time when the light receiving unit B receives the reflected light. Furthermore, the master device 100M includes the distance calculation unit 110B that calculates the distance L1 from the light projection unit A to the light receiving unit B via the ranging target 1, using the time measured by the flight time measurement unit 30 and the specification unit 110C that specifies the third distance M between the light projection unit A and the ranging target 1, using the light projection angle a of the laser light, the distance L1, and the distance L2 when the ratio of the distance L1 with respect to the distance L2 between the light projection unit A and the light receiving unit B is equal to or less than the predetermined threshold.

Therefore, in a case where the ranging target 1 is close to the light projection unit A, the third distance M between the light projection unit A and the ranging target 1 can be appropriately obtained, considering the light projection angle a of the laser light, the distance L1, and the distance L2.

Therefore, it is possible to provide the master device 100M, the ranging program, and the ranging method that can appropriately obtain the distance between the light projection unit A and the ranging target 1 even if the ranging target 1 is close to the light projection unit A.

Furthermore, when it is assumed that the distance L1 be L1, the distance L2 be L2, the third distance M be M, and the light projection angle a be a, the specification unit 110C calculates the third distance M according to the formula (1). Therefore, it is possible to provide the master device 100M, the ranging program, and the ranging method that can more appropriately obtain the distance between the light projection unit A and the ranging target 1, based on the formula (1), even if the ranging target 1 is close to the light projection unit A.

Furthermore, since the flight time measurement unit 30 measures the flight time of the light from the time when the light projection unit A projects the laser light to the time when the light receiving unit B receives the reflected light, it is possible to easily obtain the distance between the light projection unit A and the ranging target 1 with the ToF method.

Furthermore, since the predetermined threshold is the value representing a negligibly large ratio of the distance L2 with respect to the distance L1 in distance measurement, it is possible to provide the master device 100M, the ranging program, and the ranging method that can appropriately obtain the distance between the light projection unit A and the ranging target 1 even in a case where the ranging target 1 is close to the light projection unit A and the distance L2 between the light projection unit A and the light receiving unit B cannot be ignored.

Furthermore, since the specification unit 110C specifies the half distance of the distance L1 as the distance M between the light projection unit A and the ranging target 1 when the ratio between the distance L2 and the distance L1 is equal to or more than the predetermined threshold, it is possible to provide the master device 100M, the ranging program, and the ranging method that can easily obtain the distance between the light projection unit A and the ranging target 1 with the ToF method, in a case where the ranging target 1 is away from the light projection unit A and it is possible to ignore the distance L2 between the light projection unit A and the light receiving unit B.

Note that a form has been described above in which the angle table data including the data representing the light projection angle a is stored in the memory 110D and the specification unit 110C reads the data from the memory 110D. However, the data representing the light projection angle a may be acquired from the angle sensor 12A of the MEMS mirror 12 and used for calculation in the formula (1).

In the above, a form has been described in which the master device 100M includes the MCU 110 and the FPGA 130M and the FPGA 130M includes the light projection control unit 130 and the timing output unit 140 as functional blocks. However, the functional blocks of the FPGA 130M may be implemented by the MCU 110. Furthermore, at least some of the main control unit 110A, the distance calculation unit 110B, the specification unit 110C, and the memory 110D that are the functional blocks of the MCU 110 may be included in the functional blocks of the FPGA 130M. Furthermore, an application specific integrated circuit (ASIC) may be used instead of the FPGA 130M. Note that the same applies to the slave device 100S.

The ranging device, the ranging program, and the ranging method according to the exemplary embodiment of the present disclosure have been described above. However, the present disclosure is not limited to the specifically disclosed embodiment, and various changes and alterations can be made without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A ranging device comprising:
a light projection circuit configured to project laser light;
a light receiving circuit configured to receive reflected light of the laser light projected by the light projection circuit; and
a processor configured to:
measure a time from a time when the light projection circuit projects the laser light to a time when the light receiving circuit receives the reflected light;
calculate a first distance from the light projection circuit to the light receiving circuit via a ranging target, by using the time; and
specify a third distance between the light projection circuit and the ranging target, by using a light projection angle of the laser light, the first distance, and a second distance between the light projection circuit and the light receiving circuit when a ratio of the first distance with respect to the second distance is equal to or less than a predetermined threshold.

2. The ranging device according to claim 1, wherein
when the first distance, the second distance, the third distance, and the light projection angle are assumed to be L1, L2, M, and a, respectively,
the processor calculates the third distance M according to the following formula (3)
$$\text{M} = \frac{{\text{L1}}^{2} - {\text{L2}}^{2}}{2 \times \left(\text{L1} - \text{L2} \times sin \text{α}\right)} \qquad \text{[Math. 3]}$$
.

3. The ranging device according to claim 1, wherein the processor measures a flight time of light from a time when the light projection circuit projects the laser light to a time when the light receiving circuit receives the reflected light.

4. The ranging device according to claim 1, wherein the predetermined threshold is a value that represents a negligibly large ratio of the second distance with respect to the first distance, in distance measurement.

5. The ranging device according to claim 1, wherein, when a ratio between the second distance and the first distance is equal to or more than the predetermined threshold, the processor specifies a half distance of the first distance as the third distance between the light projection circuit and the ranging target.

6. A non-transitory computer-readable recording medium storing a ranging program which causes a computer to execute a processing of:
projecting, by a light projection circuit, laser light;
receiving, by a light receiving circuit, reflected light of the laser light projected by the light projection circuit; and
measuring a time from a time when the light projection circuit projects the laser light to a time when the light receiving circuit receives the reflected light;
calculating a first distance from the light projection circuit to the light receiving circuit via a ranging target, by using the time; and
specifying a third distance between the light projection circuit and the ranging target, by using a light projection angle of the laser light, the first distance, and a second distance between the light projection circuit and the light receiving circuit when a ratio of the first distance with respect to the second distance is equal to or less than a predetermined threshold.

7. A ranging method comprising:
projecting, by a light projection circuit, laser light;
receiving, by a light receiving circuit, reflected light of the laser light projected by the light projection circuit; and
measuring, by a computer, a time from a time when the light projection circuit projects the laser light to a time when the light receiving circuit receives the reflected light;
calculating a first distance from the light projection circuit to the light receiving circuit via a ranging target, by using the time; and
specifying a third distance between the light projection circuit and the ranging target, by using a light projection angle of the laser light, the first distance, and a second distance between the light projection circuit and the light receiving circuit when a ratio of the first distance with respect to the second distance is equal to or less than a predetermined threshold.
